(19) United States
(12) Patent Application Publication
(10) Pub. No.: US 2025/0289458 A1
(43) Pub. Date: Sep. 18, 2025

(54) CONTROL DEVICE, CONTROL METHOD, AND STORAGE MEDIUM

(71) Applicant: HONDA MOTOR CO., LTD., Tokyo (JP)

(72) Inventor: Tomotaka Teramachi, Tokyo (JP)

(21) Appl. No.: 19/063,409

(22) Filed: Feb. 26, 2025

(30) Foreign Application Priority Data
Mar. 18, 2024 (JP) 2024-042403

(51) Int. Cl. B60W 50/14; B60W 30/18

(52) U.S. Cl. CPC B60W 50/14; B60W 30/18163; B60W 2050/146; B60W 2552/10

(57) ABSTRACT

A control device executes traveling control processing of controlling traveling of a moving body without relying on an operation of an occupant of the moving body, causes a target display to display a screen subjected to a selection operation by the occupant from a first display screen for display related to a control state of the traveling control processing and a second display screen not for display related to the control state of the traveling control processing, and switches from the second display screen to the first display screen and causes the display to display the first display screen without relying on a selection operation of the occupant in a case in which it is judged to actually control traveling of the moving body in the traveling control processing when the occupant has selected causing the display to display the second display screen.

### CROSS-REFERENCE TO RELATED APPLICATION

Priority is claimed on Japanese Patent Application No. 2024-042403, filed Mar. 18, 2024, the content of which is incorporated herein by reference.

### BACKGROUND

### Field of the Invention

The present invention relates to a control device, a control method, and a storage medium.

### Description of Related Art

In recent years, efforts to provide sustainable transportation systems taking various situations into account have become active. In order to realize this, efforts are focused on research and development for further improvement in traffic safety and convenience through research and development related to driving assistance technologies. A vehicle guidance display device in which an image of a road ahead of a vehicle is displayed on a display and guidance arrows are created and displayed at a branching point in a manner of being superimposed on the image of a road ahead is disclosed (Japanese Unexamined Patent Application, First Publication No. H10-287177).

### SUMMARY

Technologies in the related art have not disclosed any method for displaying corresponding to a traveling state of a moving body, which may degrade convenience of an occupant of the moving body.

The present invention has been made in consideration of such circumstances, and an object thereof is to provide a control device, a control method, and a storage medium in which convenience of an occupant (for example, a driver) of a moving body can be improved. This will ultimately contribute to development of sustainable transportation systems.

A control device, a control method, and a storage medium according to this invention employ the following constitutions.

(1): A control device according to an aspect of this invention includes a storage medium storing computer-readable instructions, and at least one processor connected to the storage medium. The processor executes the computer-readable instructions to: execute traveling control processing of controlling traveling of a moving body without relying on an operation of an occupant of the moving body; cause a target display to display a screen subjected to a selection operation by the occupant from a first display screen for display related to a control state of the traveling control processing and a second display screen not for display related to the control state of the traveling control processing; and switch from the second display screen to the first display screen and cause the display to display the first display screen without relying on a selection operation of the occupant in a case in which it is judged to actually control traveling of the moving body in the traveling control processing when the occupant has selected causing the display to display the second display screen.

(2): According to the aspect of the foregoing (1), display related to the control state is display related to auto lane change control under which the moving body automatically performs a lane change.

(3): According to the aspect of the foregoing (2), the auto lane change control is executed at a branch road connected to a first lane where the moving body is traveling. The processor executes the computer-readable instructions to: cause the display to display the second display screen when the moving body is executing deceleration control for a lane change by the auto lane change control before the branch road; and cause the display to display the first display screen after the deceleration control.

(4): According to the aspect of the foregoing (1), the second display screen includes a navigation screen indicating a proceeding direction of the moving body or a direction to a destination of the moving body.

(5): According to the aspect of the foregoing (1), the second display screen includes a screen showing a fuel mileage or an electric mileage of the moving body.

(6): According to the aspect of the foregoing (5), the processor executes the computer-readable instructions to: cause the display, in a case in which it is judged to actually control traveling of the moving body in the traveling control processing, to return the first display screen to the second display screen and display the second display screen in a case in which after the second display screen is switched to the first display screen and the display is caused to display the second display screen without relying on a selection operation of the occupant, control of traveling by the traveling control processing is completed and the moving body is moving in a steady state.

(7): According to the aspect of the foregoing (2), the processor executes the computer-readable instructions to: switch from the second display screen to the first display screen and cause the display to display the first display screen without relying on a selection operation of the occupant in a case in which it is judged to execute the auto lane change control in the traveling control processing; and cause the display to return the first display screen to the second display screen and display the second display screen in a case in which the auto lane change control has been completed.

(8): A control method according to another aspect of the present invention causes a computer to execute processing of controlling traveling of a moving body without relying on an operation of an occupant of the moving body, processing of causing a target display to display a screen subjected to a selection operation by the occupant from a first display screen for display related to a control state of the processing of controlling traveling of the moving body and a second display screen not for display related to the control state, and processing of switching from the second display screen to the first display screen and causing the display to display the first display screen without relying on a selection operation of the occupant in a case in which it is judged to actually control traveling of the moving body in the processing of controlling traveling when the occupant has selected causing the display to display the second display screen.

(9): A storage medium storing a program according to another aspect of the present invention is a storage medium causing a computer to execute processing of controlling traveling of a moving body without relying on an operation of an occupant of the moving body, processing of causing a target display to display a screen subjected to a selection operation by the occupant from a first display screen for display related to a control state of the processing of controlling traveling of the moving body and a second display screen not for display related to the control state, and processing of switching from the second display screen to the first display screen and causing the display to display the first display screen without relying on a selection operation of the occupant in a case in which it is judged to actually control traveling of the moving body in the processing of controlling traveling when the occupant has selected causing the display to display the second display screen.

According to the aspects of the foregoing (1) to (9), it is possible to improve user convenience. In a case in which the first display screen and the second display screen can be displayed in a switchable manner, since the first display screen related to control is displayed depending on the timing when control actually affecting traveling of the moving body occurs, an occupant can ascertain the kind and the reason of control to be performed and the like at the timing or before the timing when traveling actually occurs.

According to the aspect of (2), in a case in which auto lane change control is performed at a branch road or the like, an occupant can ascertain the timing when a lane change in auto lane change control actually occurs by the traveling control processing.

According to the aspect of (3), the first display screen is performed before a branch after deceleration performed in advance. This first display screen is performed at the timing before lateral movement is performed after braking control so that an occupant can ascertain that a lane change is performed before lateral movement is performed.

According to the aspect of (4), even if the navigation screen has been selected, since it is switched to the first display screen related to traveling control before traveling control actually affecting traveling of the moving body occurs, an occupant can ascertain the kind and the reason of traveling control to be performed and the like before traveling of the moving body actually occurs.

According to the aspect of (5), even if a screen related to the fuel mileage or the electric mileage has been selected, since it is switched to the first display screen related to traveling control before traveling control actually affecting traveling of the moving body occurs, an occupant can ascertain the kind and the reason of traveling control to be performed and the like before traveling of the moving body actually occurs.

According to the aspect of (6), in a case in which a lane change has been completed, since the display promptly returns to the second display screen, discomfort of display to an occupant can be curbed.

According to the aspect of (7), in a case in which a lane change to an adjacent lane has been completed, since the display returns to the selected second display screen, discomfort of display to an occupant can be curbed.

### BRIEF DESCRIPTION OF THE DRAWINGS

FIG. 1 is a view of the constitution of a vehicle system utilizing a vehicle control system according to an embodiment.

FIG. 2 is an explanatory view of processing of the present embodiment (part 1).

FIG. 3 is an explanatory view of processing of the present embodiment (part 2).

FIG. 4 is a flowchart showing an example of a flow of processing executed by a driving assistance device.

FIG. 5 is an explanatory view of a scene in which a vehicle is performing a lane change.

### DETAILED DESCRIPTION OF THE INVENTION

### Overall Constitution

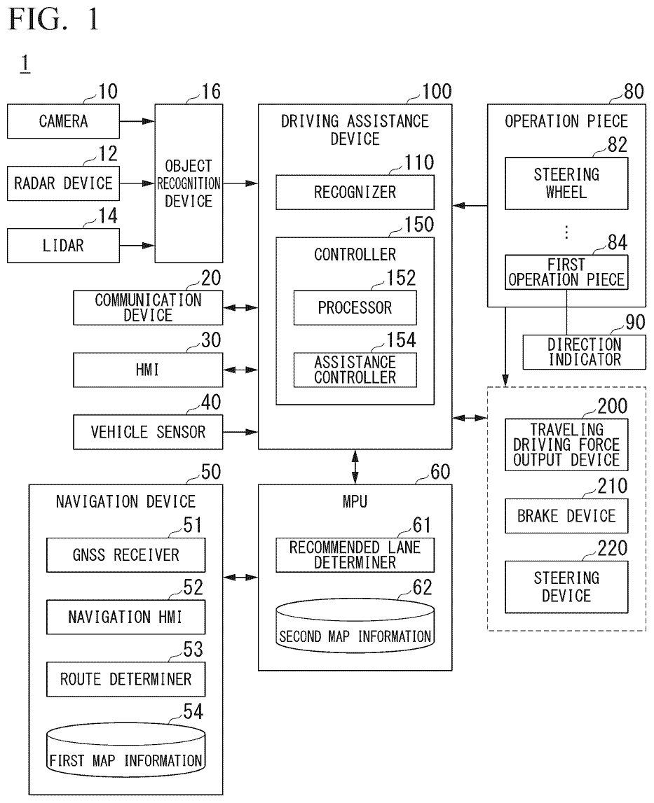

FIG. 1 is a view of the constitution of a vehicle system 1 utilizing a vehicle control system according to an embodiment. For example, a vehicle having the vehicle system 1 mounted therein is a vehicle having two wheels, three wheels, four wheels, or the like, and a drive source thereof is an internal-combustion engine such as a diesel engine or a gasoline engine, an electric motor, or a combination of these. An electric motor is operated using power generated by a generator connected to an internal-combustion engine, or discharge power of a secondary battery or a fuel cell. The present embodiment will be described as being applied to vehicles but may also be applied to other moving bodies instead of vehicles.

For example, the vehicle system 1 includes a camera 10, a radar device 12, a light detection and ranging (LIDAR) 14, an object recognition device 16, a communication device 20, a human machine interface (HMI) 30, a vehicle sensor 40, a navigation device 50, an MPU 60, an operation piece 80, a direction indicator 90, a driving assistance device 100, a traveling driving force output device 200, a brake device 210, and a steering device 220. These devices and instruments are connected to each other through multiplex communication lines such as controller area network (CAN) communication lines, serial communication lines, a wireless communication network, or the like. The constituents shown in FIG. 1 are merely an example. Some of the constituents may be omitted, and other constituents may further be added thereto. The driving assistance device 100 is an example of “a control device”.

For example, the camera 10 is a digital camera utilizing a solid-state image capturing element such as a charge coupled device (CCD) or a complementary metal oxide semiconductor (CMOS). The camera 10 is attached to an arbitrary location in the vehicle having the vehicle system 1 mounted therein (hereinafter, the vehicle M). When images on the side in front are captured, the camera 10 is attached to an upper part of a front windshield, a rear surface of a rearview mirror, or the like. For example, the camera 10 captures images around the vehicle M periodically and repeatedly. The camera 10 may be a stereo camera.

The radar device 12 radiates radio waves such as millimeter waves around the vehicle M and detects at least the location (distance and azimuth) of an object by detecting radio waves (reflected waves) reflected by the object. The radar device 12 is attached to an arbitrary location in the vehicle M. The radar device 12 may detect the location and the speed of an object by a frequency modulated continuous wave (FM-CW) method.

The LIDAR 14 emits light (or electromagnetic waves having wavelengths close to that of light) around the vehicle M and measures scattered light. The LIDAR 14 detects the distance to a target on the basis of the time from light emission to light reception. For example, emitted light is pulsed laser light. The LIDAR 14 is attached to an arbitrary location in the vehicle M.

The object recognition device 16 recognizes the location, the kind, the speed, and the like of an object by performing sensor fusion processing with respect to detection results of some or all of the camera 10, the radar device 12, and the LIDAR 14. The object recognition device 16 outputs recognition results to the driving assistance device 100. The object recognition device 16 may output the detection results of the camera 10, the radar device 12, and the LIDAR 14 to the driving assistance device 100 without any change. The object recognition device 16 may be omitted from the vehicle system 1.

For example, the communication device 20 communicates with other vehicles present around the vehicle M utilizing a cellular network, a Wi-Fi network, Bluetooth (registered trademark), dedicated short range communication (DSRC), or the like or communicates with various server devices via a wireless base station.

The HMI 30 provides various information to an occupant of the vehicle M and receives an input operation of the occupant. The HMI 30 includes various display devices, a speaker, a buzzer, a touch panel, a switch, a key, and the like. The HMI 30 includes a display device. For example, the display device is a display device (so-called multi-information display) provided in a central part of an instrument panel of the vehicle M and displaying various information in the vehicle M, such as a speedometer showing the traveling speed of the vehicle M and a tachometer showing a rotation frequency (rotational speed) of the internal-combustion engine provided in the vehicle M.

The vehicle sensor 40 includes a vehicle speed sensor for detecting the speed of the vehicle M, an acceleration sensor for detecting an acceleration, a yaw rate sensor for detecting an angular velocity around a vertical axis, an azimuth sensor for detecting a direction of the vehicle M, and the like.

For example, the navigation device 50 includes a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 identifies the location of the vehicle M on the basis of a signal received from a GNSS satellite. The location of the vehicle M may be identified or completed by an inertial navigation system (INS) utilizing an output of the vehicle sensor 40. The navigation HMI 52 includes a display device, a speaker, a touch panel, a key, and the like. Some or all of the navigation HMI 52 may be shared by the HMI 30 described above. For example, the route determiner 53 determines, with reference to the first map information 54, a route from the location of the vehicle M identified by the GNSS receiver 51 (or an arbitrary input location) to a destination input by an occupant (hereinafter, a route on the map) using the navigation HMI 52. For example, the first map information 54 is information in which road shapes are expressed by links indicating roads and nodes connected by the links. The first map information 54 may include curvatures of roads, point-of-interest (POI) information, and the like. The route on the map is output to the MPU 60. The navigation device 50 may perform route guidance using the navigation HMI 52 on the basis of the route on the map. For example, the navigation device 50 may be realized by a function of a terminal device such as a smartphone or a tablet terminal possessed by an occupant. The navigation device 50 may transmit a current location and a destination to a navigation server via the communication device 20 and acquire a route equivalent to the route on the map from the navigation server.

For example, the MPU 60 includes a recommended lane determiner 61 and retains second map information 62 in a storage device such as an HDD or a flash memory. The recommended lane determiner 61 divides the route on the map provided from the navigation device 50 into a plurality of blocks (for example, divides it into blocks of 100 [m] in a vehicle proceeding direction) and determines a recommended lane for each block with reference to the second map information 62. The recommended lane determiner 61 determines in which lane from the left the vehicle should travel.

When a branching point is present in the route on the map, the recommended lane determiner 61 determines a recommended lane such that the vehicle M can travel along a reasonable route to proceed to a branch destination. For example, when the vehicle M has arrived at a location a predetermined distance before a branch road to which it proceeds, the recommended lane determiner 61 determines a lane connected to the branch road as a recommended lane. The recommended lane determiner 61 and the second map information 62 may be a functioning part and information provided in other devices such as the driving assistance device 100.

The second map information 62 is map information that is more accurate than the first map information 54. For example, the second map information 62 includes information of the center of a lane, information of the boundary of a lane, and the like. The second map information 62 may include road information, traffic regulation information, address information (address, postal code), facility information, telephone number information, and the like. The second map information 62 may be updated at any time by the communication device 20 through communication with other devices.

For example, the operation piece 80 includes a steering wheel 82 as well as an accelerator pedal, a brake pedal, a shift lever, and other operation pieces. A sensor for detecting an amount of operation or whether there is an operation is attached to the operation piece 80, and detection results thereof are output to some or all of the driving assistance device 100, the traveling driving force output device 200, the brake device 210, and the steering device 220. The steering wheel 82 does not necessarily have an annular shape and may be in a form of a deformed steering wheel, a joystick, a button, or the like. The operation piece 80 includes a first operation piece 84. The direction indicator 90 is turned on or turned off in response to an operation of the first operation piece 84.

For example, the first operation piece 84 is a turn signal lever switch. For example, if a driver operates the first operation piece 84, the direction indicator 90 is turned on in response to the operation. If a driver performs a predetermined operation with respect to the first operation piece 84, a controller 150 starts up an auto lane change (ALC) function to cause the vehicle M to perform an auto lane change. A predetermined operation is an operation that becomes a trigger for starting up the ALC function. For example, a predetermined operation includes an operation of the turn signal lever switch performed for a predetermined period of time in a direction in which a driver desires to perform a lane change, and an operation of pushing the turn signal lever switch to a predetermined location. More specifically, a predetermined operation includes an operation of the turn signal lever switch performed for a predetermined period of time in a direction in which a driver desires to perform a lane change in state in which a predetermined location is maintained. The first operation piece 84 may be in a different form, such as a button, in place of a turn signal lever switch. In addition, the ALC function may be started up in response to an operation with respect to a different operation piece, such as a predetermined button.

For example, the driving assistance device 100 includes a recognizer 110 and the controller 150. For example, the recognizer 110 and the controller 150 are realized by a hardware processor such as a central processing unit (CPU) executing a program (software). Some or all of these constituent elements may be realized by hardware (circuit; including circuitry), such as a large-scale integration (LSI), an application specific integrated circuit (ASIC), a field-programmable gate array (FPGA), a graphics processing unit (GPU), or system on chip (SOC), or may be realized by software and hardware in cooperation. A program may be stored in a storage device such as an HDD or a flash memory (a storage device including a non-transitory storage medium) of the driving assistance device 100 in advance or may be stored in an attachable/detachable storage medium such as a DVD or a CD-ROM such that the program is installed in the HDD or the flash memory of the driving assistance device 100 when the storage medium (non-transitory storage medium) is mounted in a drive device.

The recognizer 110 recognizes states of the location, the speed, the acceleration, and the like of an object around the vehicle M on the basis of information input from the camera 10, the radar device 12, and the LIDAR 14 via the object recognition device 16. For example, the location of an object is recognized as a location on absolute coordinates with an origin at a representative point (centroid, drive shaft center, or the like) in the vehicle M and is used for control. The location of an object may be indicated by a representative point such as a centroid or a corner of the object or may be indicated as a region. A “state” of an object may include an acceleration or a jerk of the object or “an action state” (for example, whether or not it is performing a lane change or attempting a lane change).

For example, the recognizer 110 recognizes a lane in which the vehicle M is traveling (traveling lane). For example, the recognizer 110 recognizes a traveling lane by comparing the pattern of a road division line (for example, an array of solid lines and dashed line) obtained from the second map information 62 with the pattern of the road division line around the vehicle M recognized from images captured by the camera 10. The recognizer 110 may recognize a traveling lane by recognizing traveling path boundaries (road boundaries) including road division lines, road shoulders, curbstones, median strips, guardrails, and the like without being limited to road division lines. In this recognition, the location of the vehicle M acquired from the navigation device 50 or processing results of the INS may be added. The recognizer 110 recognizes stop lines, obstacles, red lights, toll gates, and other road events.

When recognizing a traveling lane, the recognizer 110 recognizes the location and the posture of the vehicle M with respect to the traveling lane. For example, the recognizer 110 may recognize a deviation of a reference point in the vehicle M from the center of the lane and an angle formed with respect to a line of the centers of the lane of the vehicle M in the proceeding direction as the relative location and a posture of the host vehicle M with respect to the traveling lane. Instead of this, the recognizer 110 may recognize a location or the like of a reference point in the vehicle M with respect to any side end part (road division line or road boundary) of the traveling lane as the relative location of the vehicle M with respect to the traveling lane.

The controller 150 executes driving assistance control. For example, the controller 150 automatically controls the speed of the vehicle M by automatically controlling the traveling driving force output device 200 and the brake device 210 without relying on a driver's operation. The controller 150 executes so-called adaptive cruise control (ACC). The controller 150 controls the vehicle M to travel at a set speed or to follow a preceding vehicle at a location a predetermined distance away from the preceding vehicle.

The controller 150 controls the steering device 220 such that the vehicle M does not deviate from the traveling lane. For example, the controller 150 controls the steering device 220 such that the vehicle M travels in the center or near the center of the traveling lane recognized by the recognizer 110. Hereinafter, this control may be referred to as “lane keeping control”. The controller 150 executes hands-on lane keeping control and hands-off lane keeping control.

The hands-on lane keeping control is control executed in a state in which a driver is gripping the steering wheel (a state in which a steering gripping sensor (not shown) has detected gripping of the steering wheel). The conditions under which the hands-on lane keeping control can be executed are less strict than the conditions under which the hands-off lane keeping control can be executed.

The hands-off lane keeping control is control executed in a state in which a driver is not gripping the steering wheel (a state in which the steering gripping sensor (not shown) has not detected gripping of the steering wheel). For example, the hands-off lane keeping control can be executed when the following conditions are satisfied: the speed of the vehicle M is equal to or higher than a predetermined speed, the vehicle M is traveling on a predetermined road (for example, a road or a type of a road that has been set in advance such that the hands-off lane keeping control can be executed), and a driver is monitoring ahead. The hands-off lane keeping control is executed when the driver is monitoring ahead, and the hands-off lane keeping control is not executed or stops when the driver is not monitoring ahead.

The conditions under which the hands-on lane keeping control and the hands-off lane keeping control can be executed are examples, and other conditions (for example, the vehicle M is following a preceding vehicle) may be included or some conditions may be omitted. The conditions under which the hands-on lane keeping control can be executed need only be less strict than the conditions under which the hands-off lane keeping control can be executed (the conditions under which the hands-off lane keeping control can be executed need only be stricter than the conditions under which the hands-on lane keeping control can be executed). The driving assistance device 100 recognizes whether a driver is monitoring ahead on the basis of images captured by the camera (not shown) capturing images of the driver.

The controller 150 includes a processor 152 (display controller) and an assistance controller 154 (traveling controller). The processor 152 causes a display to display various images. The assistance controller 154 causes the vehicle M to automatically perform a lane change. An automatically performed lane change may be controlled on condition that the hands-off lane keeping control is executed or the hands-on lane keeping control is executed.

The traveling driving force output device 200 outputs a traveling driving force (torque) for causing the vehicle M to travel to driving wheels. For example, the traveling driving force output device 200 includes a combination of an internal-combustion engine, an electric motor, a transmission, and the like, and an ECU controlling these. The ECU controls the foregoing constituents in accordance with information input from the driving assistance device 100 or information input from the operation piece 80.

For example, the brake device 210 includes a brake caliper, a cylinder transmitting a hydraulic pressure to the brake caliper, an electric motor generating a hydraulic pressure in the cylinder, and a brake ECU. The brake ECU controls the electric motor in accordance with information input from the driving assistance device 100 or information input from the operation piece 80 such that a brake torque corresponding to a braking operation is output to each of the wheels.

For example, the steering device 220 includes a steering ECU and an electric motor. For example, the electric motor causes a force to act on a rack-and-pinion mechanism to change the direction of steered wheels. The steering ECU drives the electric motor in accordance with information input from the driving assistance device 100 or information input from the operation piece 80 to change the direction of the steered wheels.

### Display Control

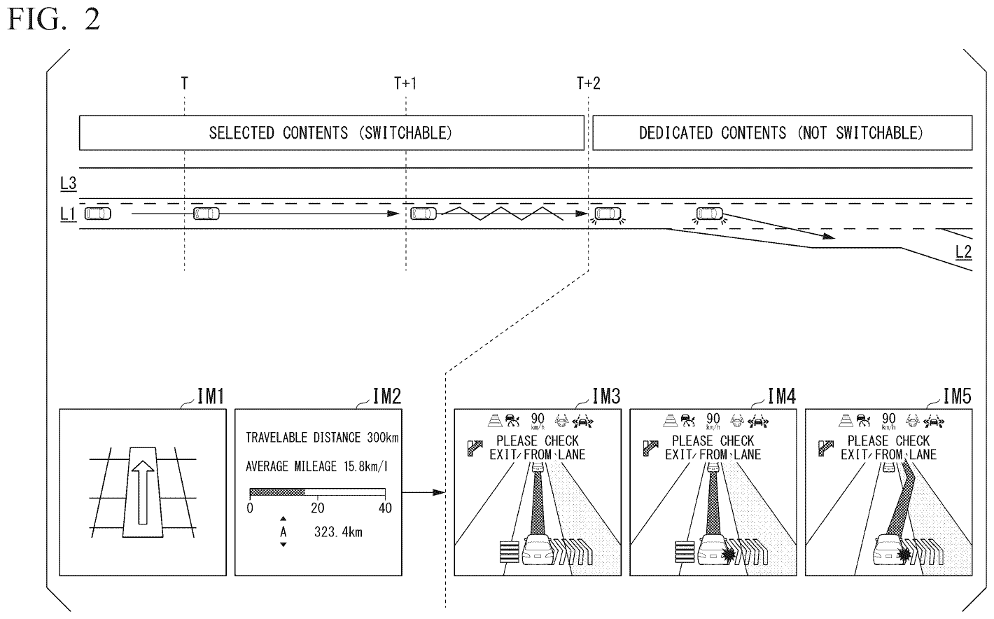

FIG. 2 is an explanatory view of processing of the present embodiment (part 1). For example, the vehicle M is traveling in a first lane L1. The vehicle M is scheduled to perform a lane change to a second lane L2 adjacent to the first lane L1. The second lane L2 is a branch lane branching from the first lane L1. For example, the following control is control executed when a target route is set for the vehicle M traveling in the second lane L2. The control is executed when an occupant (driver) of the vehicle M performs an operation of instructing the vehicle M to perform a lane change to the second lane L2 a predetermined distance before a connection location where the first lane L1 and the second lane L2 are connected. For example, an instructing operation is any operation such as an operation of a reservation button for a predetermined lane change or an operation of the first operation piece 84. For example, branching assistance control in which a lane change to a branch lane is performed automatically by operating the reservation button is executed.

For example, when approaching a branch lane, the assistance controller 154 automatically performs deceleration, turns on the direction indicator 90 at an appropriate timing, and automatically controls steering without relying on a driver's operation to cause the vehicle M to perform a lane change to the branch lane. For example, this assistance control may be performed when the hands-off lane keeping control or the hands-on lane keeping control is executed.

A time T is a timing when the vehicle M has arrived at a location a first predetermined distance before a connection location. A time T+1 is a timing when the vehicle M has arrived at a location a second predetermined distance before the connection location. The second predetermined distance is a distance shorter than the first predetermined distance. A time T+2 is a timing when the vehicle M has arrived at a location a third predetermined distance before the connection location. The third predetermined distance is a distance shorter than the second predetermined distance. The time T+2 is a timing when the direction indicator 90 is turned on. A time T+3 is a timing when a lane change to the second lane L2 starts (or a timing immediately before it starts).

Until the time T+2, selected contents can be displayed (or displayed) in the display, and until a time T+5 (which will be described below) after the time T+2, dedicated contents are displayed in the display. After the time T+5, the selected contents can be displayed (or displayed) in the display.

The selected contents are an example of “a second display screen which is not for display related to the control state of the traveling controller”. The dedicated contents are an example of “a first display screen which is for display related to the control state of the traveling controller”. The dedicated contents are in a screen related to so-called advanced driver-assistance systems (ADAS). For example, the dedicated contents are display related to control or the function of the ADAS. For example, until the time T+2 or after the time T+5, the processor 152 causes the target display to display a screen of the selected contents (one or a plurality of selected contents) or the dedicated contents subjected to a selection operation by an occupant.

For example, the selected contents are display different from the display related to the control state of the vehicle M (lane change, lane keeping control, ACC, and the like) of the assistance controller 154, such as an image IM1 and an image IM2. An occupant can cause the display to display arbitrary contents from a plurality of selected contents by performing a predetermined operation. For example, the processor 152 causes the display to display the image IM2 in place of the image IM1 in response to an operation of an occupant. The image IMI is a navigation screen indicating the proceeding direction of the vehicle M or a direction of a destination of the vehicle M. The image IM2 is a screen showing a fuel mileage or an electric mileage of the vehicle M.

When an occupant has selected causing the display to display the selected contents, in a case in which it is judged that the assistance controller 154 actually controls traveling of the vehicle M, the processor 152 switches from the selected contents to the dedicated contents and causes the display to display the dedicated contents without relying on a selection operation of an occupant. A timing when “it is judged that the assistance controller 154 actually controls traveling of the vehicle M” is a timing when the assistance controller 154 starts a lane change of the vehicle M, a predetermined time before the foregoing start timing, a predetermined time after the foregoing start timing, a timing when the direction indicator 90 is turned on in response to the start of a lane change, or the like.

At the time T+2, at a timing when the vehicle M starts a lane change, the processor 152 causes the display to display the dedicated contents in place of the selected contents. The dedicated contents are display related to auto lane change control of causing the vehicle M to automatically perform a lane change, such as an image IM3, an image IM4, and an image IM5. For example, in a section from the time T+1 to the time T+2 (a section before a branch road), the assistance controller 154 causes the vehicle M to decelerate for a lane change. During this time, the processor 152 causes the display to display the selected contents. At the time T+2 after deceleration control has been performed, the processor 152 causes the display to display the dedicated contents. This example describes that the dedicated contents are displayed after deceleration control is performed, but the dedicated contents may be displayed before deceleration control starts or at a timing when it is determined to perform a lane change.

The image IM3, the image IM4, and the image IM5 are displayed in the display in this order. The image IM3 includes the first lane L1, a third lane L3 which is adjacent to the first lane, the second lane L2 which is a branch lane adjacent to the first lane, the vehicle M (the vehicle at the bottom in the image), information indicating a future trajectory of the vehicle M, and directional information (arrows) indicating a direction in which the vehicle M performs a lane change. The directional information is associated with the vehicle M in the image IM3. The first lane L1, the second lane L2, and the third lane L3 are images generated from recognition results of the recognizer 110 (images captured by the camera 10).

The image IM4 is displayed such that the color of the directional information in the image IM4 differs from the color of the directional information in the image IM3 and information indicating that the direction indicator 90 is turned on in the image of the vehicle M is added thereto. It is otherwise the same. The image IM5 is an image showing that the trajectory of the vehicle M proceeds from the first lane L1 to the second lane L2 in the image IM4. The image IM5 is an image displayed in the display before the vehicle M enters the second lane L2 or before a lane change is completed. Completion of a lane change denotes that the vehicle M has moved to a branch road (has moved to a location near the center of a branch road), the vehicle M has traveled a predetermined distance after it has moved to a branch road, or the like.

As described above, the processor 152 causes the display to display the dedicated contents in place of the selected contents at the timing when the vehicle M starts a lane change, and therefore an occupant can ascertain the kind and the reason of control to be performed and the like at the timing or before the timing when a lane change actually occurs. As a result, user convenience is improved.

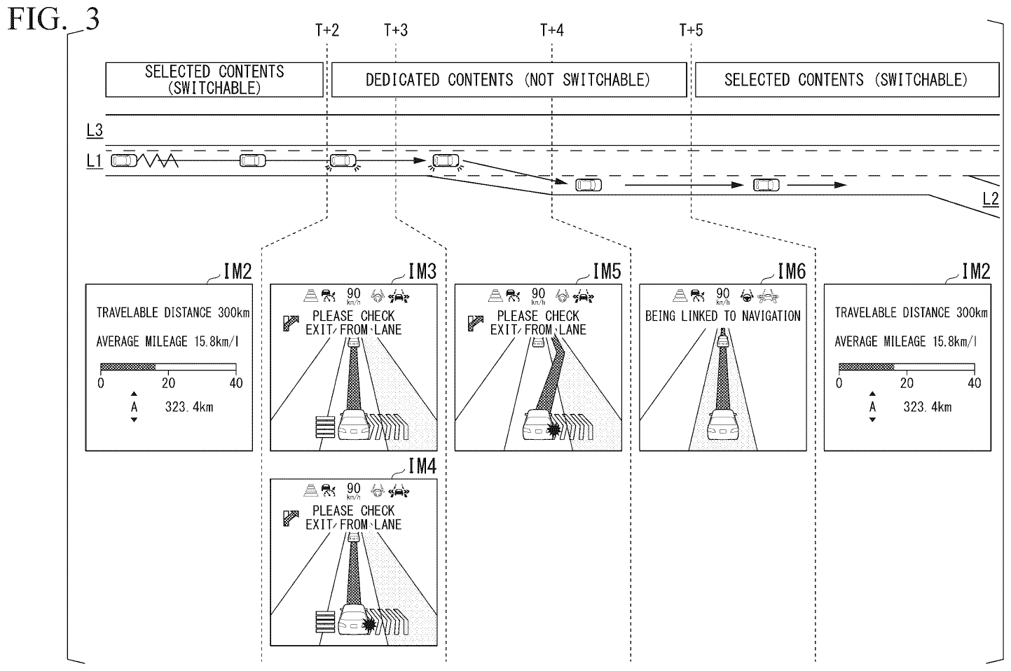

FIG. 3 is an explanatory view of processing of the present embodiment (part 2). FIG. 3 shows a scene after the time T+2 shown in FIG. 2. The image IM5 is displayed at the time T+3. At this time or thereafter, the vehicle M starts a lane change. At a time T+4, if the vehicle M performs a lane change and moves to the second lane L2, an image IM6 is displayed. The image IM6 includes the first lane L1 recognized by the recognizer 110, the second lane L2 recognized by the recognizer 110, the vehicle M (the vehicle at the bottom in the image), and information indicating a future trajectory of the vehicle M.

When the image IM6 is being displayed, it is linked to navigation at the time T+2 and before the time T+2. Being linked to navigation denotes that the processor 152 causes the display to display an image or can cause the display to display an image utilizing information of the navigation device 50 (for example, information on a road such as a lane). Accordingly, the processor 152 can identify the timing when the display is caused to display the dedicated contents.

When control of traveling by the assistance controller 154 is completed and the vehicle M is moving in a steady state, the processor 152 returns the dedicated contents to the selected contents and causes the display to display the selected contents. For example, when auto lane change control has been completed, the processor 152 returns the dedicated contents to the selected contents and causes the display to display the selected contents. It is assumed that a lane change has been completed at the time T+5. In this case, the processor 152 causes the display to display the selected contents which have been displayed in the display before the time T+2 in place of the dedicated contents.

As described above, when a lane change has been completed, since the processor 152 promptly returns display to the selected contents, discomfort of display to an occupant can be curbed. Moreover, an occupant can recognize information which he/she desires to recognize in the selected contents. As a result, user convenience is improved.

### Flowchart

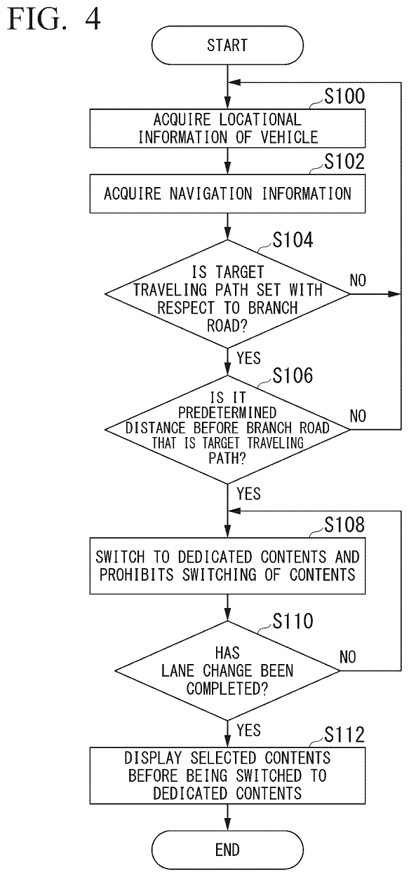

FIG. 4 is a flowchart showing an example of a flow of processing executed by the driving assistance device 100. First, the processor 152 acquires locational information of the vehicle M (Step S100). Next, the processor 152 acquires navigation information (Step S102). The navigation information includes information of a destination set in the navigation device 50, information of a target traveling path of the vehicle M guided by the navigation device 50, structures of roads around the target traveling path, and the like. The processing of Step S100 and Step S102 is repeatedly executed at predetermined intervals.

Next, the processor 152 judges whether or not a target traveling path is set for a branch road on the basis of the information acquired in Step S100 and S102 (Step S104). When no target traveling path is set for the branch road, the processing returns to Step S100. When a target traveling path is set for the branch road, the processor 152 judges whether or not the vehicle M has arrived at a location a predetermined distance before the branch road which is the target traveling path (Step S106). When the vehicle M has not arrived at the location a predetermined distance before the branch road which is the target traveling path, the processing returns to Step S100. It is assumed that the selected contents are displayed in the display up to Step S106.

When the vehicle M has arrived at a location a predetermined distance before a branch road which is the target traveling path, the processor 152 switches from the selected contents to the dedicated contents and causes the display to display the dedicated contents (Step S108). Next, the processor 152 judges whether or not a lane change has been completed (Step S110). When a lane change has not been completed, the processing returns to Step S108. When a lane change has been completed, the processor 152 causes the display to display the selected contents before being switched to the dedicated contents (Step S112). Accordingly, the processing of one routine of this flowchart ends.

In place of the processing of the foregoing Step S110, it may be judged whether or not conditions are satisfied. For example, the conditions are that the vehicle M has arrived at a predetermined location, that the state of the vehicle M has satisfied arbitrary conditions, and the like. For example, the state of the vehicle M satisfying arbitrary conditions denotes that the direction indicator is turned off, that a predetermined period of time has elapsed after the direction indicator has been turned off, and the like.

In the foregoing example, control in a scene in which the vehicle M proceeds to a branch road has been described. However, in place of (or in addition to) this, control having a purpose similar to that described above may also be executed in a scene in which the vehicle M performs a lane change.

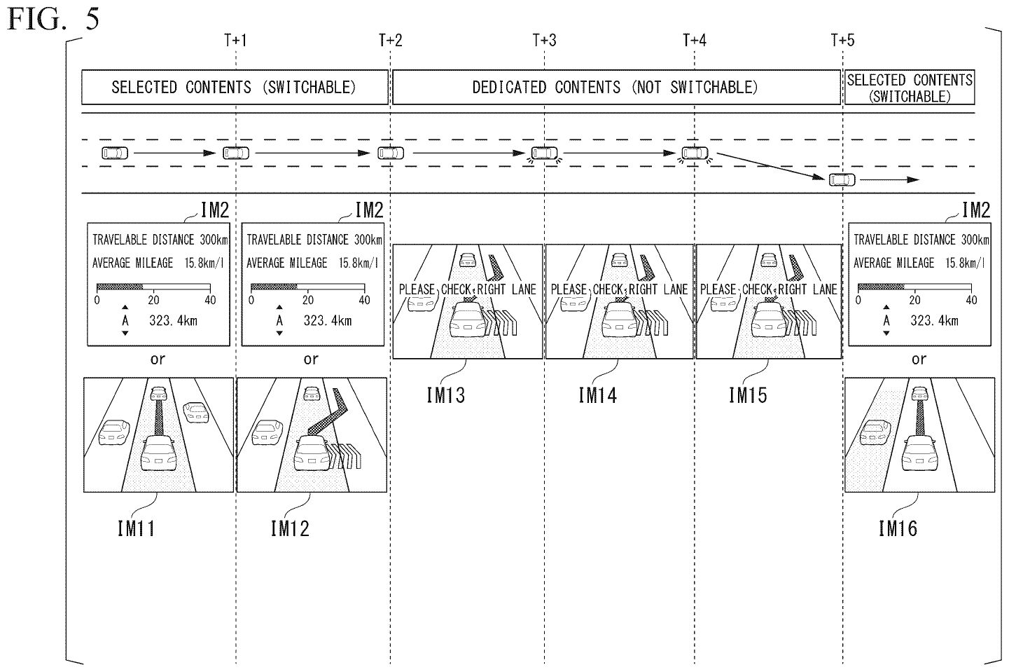

FIG. 5 is an explanatory view of a scene in which the vehicle M is performing a lane change. For example, when a slower vehicle is present ahead of the vehicle M at the time T+1, it is assumed that it is judged to perform a lane change. In FIG. 5, depiction of surrounding vehicles is omitted. For example, it is assumed that a driver has instructed to perform an auto lane change. At the time T+2, the vehicle M has recognized the situation of the adjacent lane of the vehicle M and has judged that a lane change can be performed. The vehicle M has started a lane change at the time T+3. A lane change is being performed at the time T+4. It is assumed that a lane change has been completed at the time T+5.

Until the time T+2, the selected contents are displayed. During the period from the time T+2 to the time T+5, the dedicated contents are displayed. After the time T+5 has passed, the selected contents are displayed. For example, until the time T+2 and after the time T+5 has passed, the image IM2 having the selected contents is displayed.

In addition, when a driver has selected an image showing the situation around the vehicle M as the selected contents, until the time T+2 and after the time T+5 has passed, an image IM11, an image IM12, and an image IM16 showing the situation around the vehicle M may be displayed. The image IM11 is an image displayed before the time T+1. The image IM11 shows vehicles, road division lines, and the like present around the vehicle M (depiction of other vehicles is omitted in the diagram of a road shown at the top in the image). The image IM12 includes information indicating a future trajectory of the vehicle M and directional information (arrows) indicating a direction in which the vehicle M performs a lane change in addition to the contents of the image IM11. The image IM11, the image IM12, and the image IM16 may be another example of the selected contents. The image IM11, the image IM12, and the image IM16, and an image IM13, an image IM14, and an image IM15 have both the selected contents and the dedicated contents, for example. When the image IM11, the image IM12, and the image IM16 which are images indicating the surrounding situation as the selected contents are selected, even in a section where the dedicated contents are displayed, the image IM13, the image IM14, and the image IM15 indicating the surrounding situation corresponding to the image IM11, the image IM12, and the image IM16 indicating the surrounding situation are displayed without any change.

The image IM13 is displayed at the time T+2, the image IM14 is displayed at the time T+3, and the image IM15 is displayed at the time T+4. The image IM13, the image IM14, and the image IM15 include information requesting a driver to check the surroundings such as the lane of the lane change destination. The image IM13 includes information indicating a future trajectory of the vehicle M and directional information (arrows) indicating a direction in which the vehicle M performs a lane change. In the image IM14, the color of the directional information may be displayed differently from the color of the directional information of the image IM13. In the image IM15, the color of the directional information may be displayed differently from the color of the directional information of the image IM14. For example, the directional information may be displayed in a form in which a lane change of the vehicle M is further emphasized.

When a lane change is completed and the vehicle M is moving in a steady state at the time T+5, the dedicated contents are returned to the selected contents and the display is caused to display the selected contents. For example, the image IM2 or the image IM16 is displayed. The image IM16 has contents showing the situation around the vehicle M.

If the flowchart in FIG. 4 is applied to a lane change, the judgment in Step S100 and Step S102 is omitted. The processing of Step S104 can be reworded as “the processor 152 judges whether or not the vehicle M is scheduled to perform a lane change”, and the processing of Step S106 can be reworded as “the processor 152 judges whether or not to perform a lane change”.

As described above, the processor 152 causes the display to display the dedicated contents in place of the selected contents at the timing when the vehicle M starts a lane change, and therefore user convenience can be improved.

According to the embodiment described above, the driving assistance device 100 switches from the selected contents (second display screen) to the dedicated contents (first display screen) and causes the display to display the dedicated contents without relying on a selection operation of an occupant in a case in which the assistance controller 154 judges to actually control traveling of the vehicle M when the occupant has selected causing the display to display the selected contents (second display screen), and therefore user convenience can be improved.

The embodiment described above can be expressed as follows.

A control device is constituted to include a storage device storing a program, and a hardware processor. The hardware processor executes the program stored in the storage device to execute processing of controlling traveling of a moving body without relying on an operation of an occupant of the moving body, processing of causing a target display to display a screen subjected to a selection operation by the occupant from a first display screen for display related to a control state and a second display screen not for display related to the control state of a traveling controller, and processing of switching from the second display screen to the first display screen and causing the display to display the first display screen without relying on a selection operation of the occupant in a case in which it is judged to actually control traveling of the moving body in the processing of controlling traveling when the occupant has selected causing the display to display the second display screen.

Hereinabove, forms for performing the present invention have been described using an embodiment. However, the present invention is not limited to such an embodiment in any way, and various modifications and replacements can be added thereto within a range not departing from the gist of the present invention.

What is claimed is:

1. A control device comprising:
a storage medium storing computer-readable instructions; and
at least one processor connected to the storage medium, wherein the processor executes the computer-readable instructions to:
execute traveling control processing of controlling traveling of a moving body without relying on an operation of an occupant of the moving body;
cause a target display to display a screen subjected to a selection operation by the occupant from a first display screen for display related to a control state of the traveling control processing and a second display screen not for display related to the control state of the traveling control processing; and
switch from the second display screen to the first display screen and cause the display to display the first display screen without relying on a selection operation of the occupant in a case in which it is judged to actually control traveling of the moving body in the traveling control processing when the occupant has selected causing the display to display the second display screen.

2. The control device according to claim 1,
wherein display related to the control state is display related to auto lane change control under which the moving body automatically performs a lane change.

3. The control device according to claim 2,
wherein the auto lane change control is executed at a branch road connected to a first lane where the moving body is traveling, and
the processor executes the computer-readable instructions to:
cause the display to display the second display screen when the moving body is executing deceleration control for a lane change by the auto lane change control before the branch road; and
cause the display to display the first display screen after the deceleration control.

4. The control device according to claim 1,
wherein the second display screen includes a navigation screen indicating a proceeding direction of the moving body or a direction to a destination of the moving body.

5. The control device according to claim 1,
wherein the second display screen includes a screen showing a fuel mileage or an electric mileage of the moving body.

6. The control device according to claim 1,
wherein the processor executes the computer-readable instructions to: cause the display, in a case in which it is judged to actually control traveling of the moving body in the traveling control processing, to return the first display screen to the second display screen and display the second display screen in a case in which after the second display screen is switched to the first display screen and the display is caused to display the first display screen without relying on a selection operation of the occupant, control of traveling by the traveling control processing is completed and the moving body is moving in a steady state.

7. The control device according to claim 2,
wherein the processor executes the computer-readable instructions to:
switch from the second display screen to the first display screen and cause the display to display the first display screen without relying on a selection operation of the occupant in a case in which it is judged to execute the auto lane change control in the traveling control processing; and
cause the display to return the first display screen to the second display screen and display the second display screen in a case in which the auto lane change control has been completed.

8. A control method for causing a computer to execute
processing of controlling traveling of a moving body without relying on an operation of an occupant of the moving body,
processing of causing a target display to display a screen subjected to a selection operation by the occupant from a first display screen for display related to a control state of the processing of controlling traveling of the moving body and a second display screen not for display related to the control state, and
processing of switching from the second display screen to the first display screen and causing the display to display the first display screen without relying on a selection operation of the occupant in a case in which it is judged to actually control traveling of the moving body in the processing of controlling traveling when the occupant has selected causing the display to display the second display screen.

9. A storage medium storing a program for causing a computer to execute
processing of controlling traveling of a moving body without relying on an operation of an occupant of the moving body,
processing of causing a target display to display a screen subjected to a selection operation by the occupant from a first display screen for display related to a control state of the processing of controlling traveling of the moving body and a second display screen not for display related to the control state, and
processing of switching from the second display screen to the first display screen and causing the display to display the first display screen without relying on a selection operation of the occupant in a case in which it is judged to actually control traveling of the moving body in the processing of controlling traveling when the occupant has selected causing the display to display the second display screen.
